(19) United States
(12) Patent Application Publication
(10) Pub. No.: US 2022/0138232 A1
(43) Pub. Date: May 5, 2022

(54) VISUALIZATION METHOD, VISUALIZATION DEVICE AND COMPUTER-READABLE STORAGE MEDIUM

(71) Applicant: NEC Corporation, Minato-ku, Tokyo (JP)

(72) Inventors: Daniel Georg ANDRADE SILVA, Tokyo (JP); Yuzuru OKAJIMA, Tokyo (JP)

(73) Assignee: NEC Corporation, Minato-ku, Tokyo (JP)

(21) Appl. No.: 17/434,052

(22) PCT Filed: Feb. 28, 2019
(86) PCT No.: PCT/JP2019/007892

§ 371 Date: Aug. 26, 2021

(51) Int. Cl. G06F 16/28; G06F 16/22

(52) U.S. Cl. CPC G06F 16/287; G06F 16/2246

(57) ABSTRACT

A visualization device visualizes plural clustering results. The clustering result ordering unit orders plural clustering results based on quality criteria. Each of the clustering results includes covariate clusters. The hierarchical arrangement unit creates hierarchical tree structure including the covariate clusters as nodes. The created hierarchical structure is displayed.

### TECHNICAL FIELD

The present invention relates to a technique of visualizing a hierarchical structure of clustering results.

### BACKGROUND ART

In a field of classification, there is a need of visualizing multiple clustering results in such a manner that significance and relative association of covariate clusters can be easily understood. In this respect, NPL 1 proposes hierarchical display of covariates in convex clustering.

### CITATION LIST

### Non Patent Literature

[NPL 1]

Eric C. Chie and Kenneth Lange, “Splitting methods for convex clustering”, Journal of Computational and Graphical Statistics, 24(4):994-1013, 2015.

### SUMMARY OF INVENTION

### Technical Problem

While NPL 1 displays the hierarchical relation of the covariate clusters, significance of covariates cannot be grasped.

One example of an object of the present invention is to visualize plural clustering results in such a manner that significance and relative association of covariate clusters can be easily understood.

### Solution to Problem

According to one aspect of the invention, there is provided a visualization method of clustering results, comprising:
ordering plural clustering results based on quality criteria, each of the clustering results including covariate clusters;
creating a hierarchical structure including the covariate clusters as nodes; and
displaying the hierarchical structure.

According to another aspect of the invention, there is provided a visualization device of clustering results, comprising:
a memory storing instructions; and
a processor executing the instructions to:
order plural clustering results based on quality criteria, each of the clustering results including covariate clusters;
create a hierarchical structure including the covariate clusters as nodes; and
display the hierarchical structure.

According to still another aspect of the invention, there is provided a non-transitory computer-readable storage medium storing instructions that, when executed by a processor, cause the processor to:
order plural clustering results based on quality criteria, each of the clustering results including covariate clusters;
create a hierarchical structure including the covariate clusters as nodes; and
display the hierarchical structure.

### Advantageous Effect of Invention

According to the invention, the clustering results can be visualized in a hierarchical structure to show significance and relative association of the covariates clusters.

### BRIEF DESCRIPTION OF DRAWINGS

FIG. 1 is a block diagram schematically illustrating a hardware configuration of a visualization device according to a first example embodiment of the invention.

FIG. 2 is a block diagram schematically illustrating a functional configuration of the visualization device according to the first example embodiment.

FIGS. 3(A) and 3(B) are flowcharts of hierarchical visualization processing executed by the hierarchical visualization device of the first example embodiment.

FIG. 4 shows examples of clustering results and weight matrices.

FIGS. 5(A) and 5(B) illustrate an example of adding covariate clusters to a hierarchical structure.

FIGS. 6(A) and 6(B) illustrate an example of adding the covariate clusters to the hierarchical structure.

FIG. 7 illustrates a first example of the hierarchical visualization of the clustering results.

FIG. 8 illustrates a second example of the hierarchical visualization of the clustering results.

FIG. 9 illustrates a third example of the hierarchical visualization of the clustering results.

FIG. 10 illustrates a fourth example of the hierarchical visualization of the clustering results.

FIG. 11 illustrates a fifth example of the hierarchical visualization of the clustering results.

FIG. 12 illustrates a sixth example of the hierarchical visualization of the clustering results.

FIG. 13 illustrates a seventh example of the hierarchical visualization of the clustering results.

FIG. 14 illustrates a functional configuration of the visualization device according to a second example embodiment.

### DESCRIPTION OF EMBODIMENTS

### First Embodiment

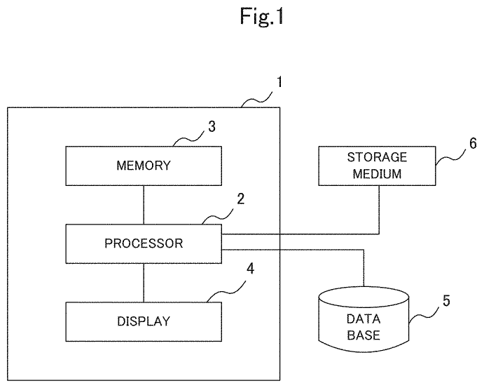

FIG. 1 is a block diagram schematically illustrating a hardware configuration of a visualization device according to a first example embodiment of the invention. As illustrated, the visualization device 1 includes a processor 2, a memory 3 and a display 4. The processor 2 is connected to a database 5 and a storage medium 6.

The processor 2 is typically a CPU, and executes various processing necessary for the visualization device 1. The processor 2 executes a program prepared in advance to achieve the various processing. The memory 3 typically includes a ROM and a RAM, and stores necessary programs to be executed by the processor 2. Also, the memory 3 serves as a work memory during execution of various processing by the processor 2. The display 4 is typically a Liquid Crystal display, and presents a hierarchical structure of covariate clusters to a user. The storage medium 6 may be a flash memory or a disk-type recording medium, for example, and store programs to be executed by the processor 2. The programs may be supplied from the storage medium 6 to the memory 3. The storage medium 6 is an example of a non-transitory computer-readable storage medium of the present invention. The database 5 stores various information that the visualization device 1 uses to visualize the hierarchical structure of clustering results. Specifically, the database 5 stores plural clustering results {H₁, . . . , H_{L}}, quality criteria {q₁, . . . ,q_{L}} of the clustering results, and weight matrix Bᵢ of a trained multinomial linear classifier.

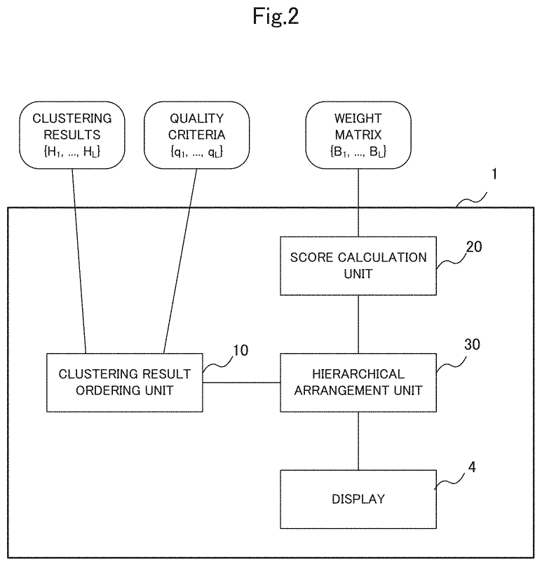

FIG. 2 is a block diagram schematically illustrating a functional configuration of the visualization device according to the first example embodiment. In addition to the display 4, the visualization device 1 includes a clustering result ordering unit 10, a score calculation unit 20 and a hierarchical arrangement unit 30. The clustering result ordering unit 10 obtains the clustering results {H₁, . . . , H_{L}} and the quality criteria {q₁, . . . , q_{L}} from the database 5, and orders the clustering results {H₁, . . . , H_{L}} in accordance with the order of the quality criteria {q₁, . . . , q_{L}}.

The score calculation unit 20 obtains the weight matrix Bᵢ from the database 5. The score calculation unit 20 calculates the class and the score of each covariate cluster by using the weight matrix Bᵢ, and supplies the classes and the scores to the hierarchical arrangement unit 30.

The hierarchical arrangement unit 30 creates a hierarchical arrangement of the covariate clusters based on the clustering results supplied from the clustering result ordering unit 10 and the class and score of each covariate clusters supplied from the score calculate unit 20. Specifically, the hierarchical arrangement unit 30 creates a hierarchical structure (i.e., one or more trees), wherein each hierarchical level corresponds to one clustering result Hᵢ and each node corresponds to one covariate cluster. Also, in the hierarchical structure, each covariate cluster is associated with its class, and the score of the each covariate cluster is shown in association with the corresponding node. The hierarchical arrangement unit 30 supplies the created hierarchical structure to the display 4 to be presented to a user.

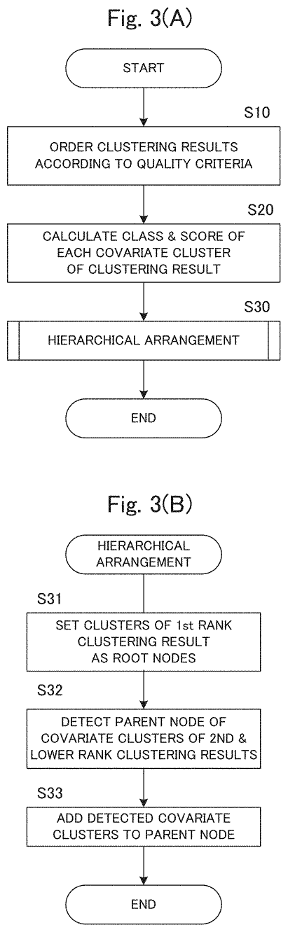

Next, the hierarchical arrangement of the clustering results according to this embodiment will be specifically described. FIGS. 3(A) and 3(B) are flowcharts of hierarchical visualization processing executed by the hierarchical visualization device 1. Before starting the processing of FIG. 3(A), the hierarchical visualization device 1 prepares the following information:

(1) A set of clustering results {H₁, . . . , H_{L}}

(2) Quality criteria {q₁, . . . , q_{L}} for the clustering results {H₁, . . . , H_{L}} (e.g., marginal likelihood, held-out test accuracy, etc.)

(3) A trained multinomial logistic linear classifier with weight matrix Bᵢ

Also, labels of covariates (e.g., {fantastic}, {great}, {bad}, {actor}, etc.) and labels of classes (e.g., “Good Movie” and “Bad Movie”) are given.

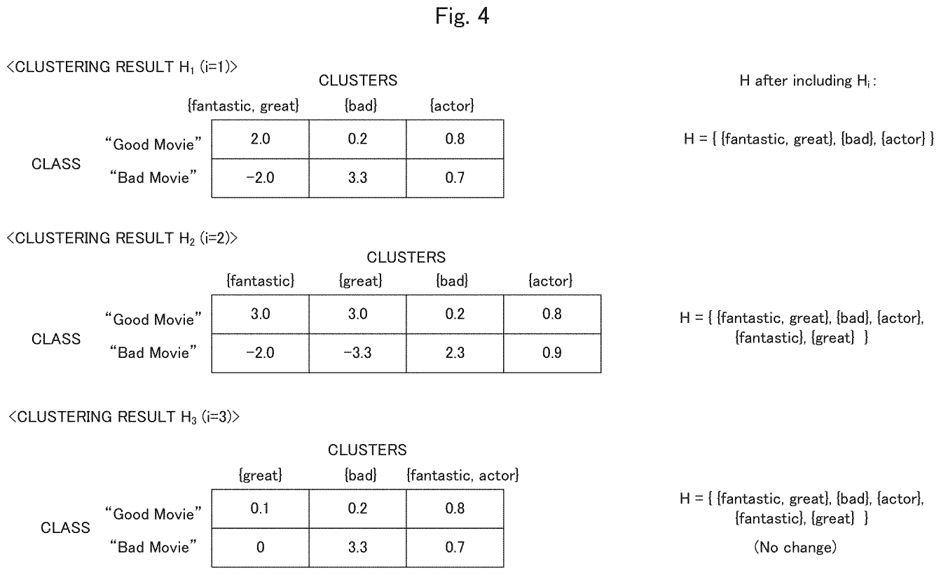

FIG. 4 shows examples of the clustering results and the weight matrices. As shown in FIG. 4, these examples relate to a classification to two classes, i.e., “Good Movie” and “Bad Movie”, and there are three clustering results H₁ to H₃. The clustering result H₁ includes the covariate clusters {fantastic, great}, {bad} and {actor}, and the weight values of the weight matrix B₁ for each covariate cluster are shown in the table. For example, the weight value of the covariate cluster {fantastic, great} for the class “Good Movie” is “2.0”, and the weight value of the covariate cluster {fantastic, great} for the class “Bad Movie” is “−2.0”. The weight value indicates how strongly the covariate cluster is associated with the class. The weight values “2.0” and “−2.0” of the covariate cluster {fantastic, great] indicates that the covariate cluster {fantastic, great} is more associated with the class “Good Movie” than the class “Bad Movie”.

Similarly, the clustering result H₂ includes the covariate clusters {fantastic}, {great}, {bad} and {actor}, and the weight values of the weight matrix B₂ for each covariate cluster are shown in the table. The clustering result H₃ includes the covariate clusters {great}, {bad} and {fantastic, actor}, and the weight values of the weight matrix B₃ for each covariate cluster are shown in the table.

Based on the above information, the clustering result ordering unit 10 orders the clustering results according to the quality criteria (step S10). Specifically, the clustering result ordering unit 10 orders the clustering results {H₁, . . . , H_{L}} from the one having the highest quality to the one having the lowest quality. In other words, the clustering result ordering unit 10 generates a ranking of the clustering results based on the quality criteria. For simplicity, it is hereinafter assumed that the clustering result ordering unit 10 ordered the inputted clustering results in the order of {H₁, . . . , H_{L}}, i.e., the clustering result H₁ has the highest quality and the clustering result H_{L} has the lowest quality. Therefore, in the examples of FIG. 4, the clustering result H₁ has the highest quality, the clustering result H₂ has the second highest quality and the clustering result H₃ has the lowest quality. Hereinafter, the clustering result H₁ will be referred to as “first rank clustering result”, the clustering result H₂ will be referred to as “second rank clustering result”, and the clustering result H₃ will be referred to as “third rank clustering result”. The clustering result ordering unit 10 supplies the clustering results thus ordered to the hierarchical arrangement unit 30.

Next, the score calculation unit 20 calculates the class and score of each covariate cluster of the clustering results (step S20). Specifically, the score calculation unit 20 calculates the class and score associated with each covariate cluster using the weight matrix Bᵢ of the trained multinomial linear classifier. For example, in case of a multinomial logistic regression classifier, the class of the covariate cluster Cᵢ may be determined as the class that provides a largest weight value in the weight matrix Bᵢ for the covariate cluster Cᵢ. Also, the score for the covariate cluster Cᵢ may be calculated as follows:

score=exp(Bₘₐₓ−B₂ₘₐₓ),

wherein “Bₘₐₓ” is a largest weight value in the weight matrix Bᵢ for the covariate cluster Cᵢ, and “B₂ₘₐₓ” is a second largest weight value in the weight matrix Bᵢ for the covariate cluster Cᵢ. It is noted that the class and score may be calculated by other calculation method.

Next, the hierarchical arrangement unit 30 creates the hierarchical structure of the covariate clusters (step S30). Specifically, the hierarchical arrangement unit 30 creates a forest (i.e., one or more trees), in which one tree corresponds to a hierarchical clustering of the covariates that belong to the root node. FIG. 3(B) shows a flowchart of the hierarchical arrangement in step S30. First, the hierarchical arrangement unit 30 sets the covariate clusters of the first rank clustering result H₁ as root nodes of the tree structure (step S31). Next, the hierarchical arrangement unit 30 detects the parent node for each of the covariate clusters of the second rank clustering result H2 and the lower rank clustering results H₃ to H_{L} (step S32). For example, when there is a node N1 corresponding to the covariate cluster {fantastic, great}, and there is a covariate cluster C1={fantastic} at the lower level of the node N1, the node N1 is the parent node of the cluster C1. The hierarchical arrangement unit 30 detects the parent node for all the covariate clusters of the second and lower rank clustering results.

Next, the hierarchical arrangement unit 30 adds the covariate clusters detected in step S32 to the hierarchical structure (step S32). Specifically, the hierarchical arrangement unit 30 adds the cluster to the position of the child node of the parent node in the hierarchical structure. The hierarchical arrangement unit 30 adds the covariate clusters in the order from the second rank clustering result H₂ to the lowest rank clustering result H_{L}.

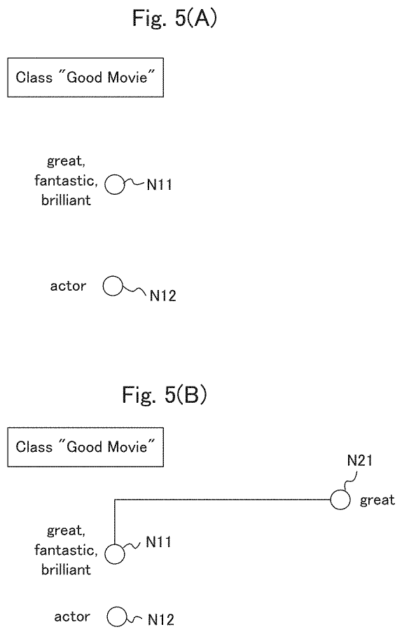

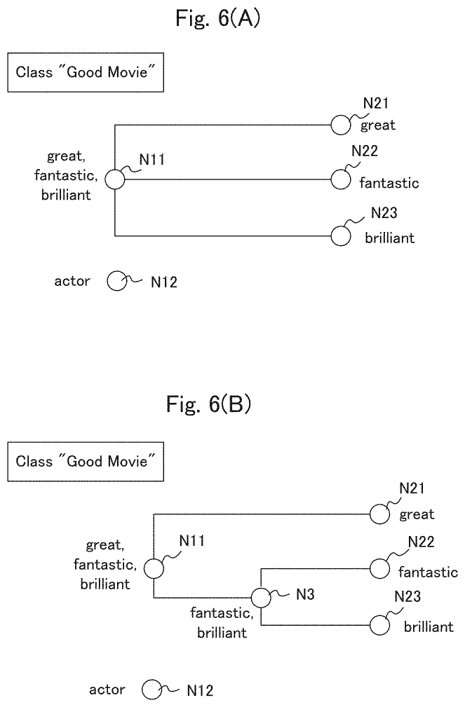

Next, the example of adding the covariate clusters will be described. FIGS. 5(A), 5(B), 6(A) and 6(B) illustrate examples of adding the covariate clusters to the hierarchical structure. It is now assumed that the first rank clustering result includes the covariate clusters {great, fantastic, brilliant} and {actor} for the class “Good Movie” as shown in FIG. 5(A). The hierarchical arrangement unit 30 sets the covariate cluster {great, fantastic, brilliant} as a root node N11, and sets the covariate cluster {actor} as a root node N12. Here, illustration of the covariate clusters for the class “Bad Movie” is omitted for simplicity. It is also assumed that the second rank clustering result includes the covariate clusters {great}, {fantastic} and {brilliant}.

The hierarchical arrangement unit 30 first detects the parent node for the covariate cluster {great}. Since the covariate cluster {great} is a subset of the covariate cluster {great, fantastic, brilliant} at the node N11, the node N11 is the parent node of the covariate cluster {great}, and the hierarchical arrangement unit 30 adds the covariate cluster {great} at the child position of the node N11 to form the node N21 as shown in FIG. 5(B). Similarly, since each of the covariate clusters {fantastic} and {brilliant} is a subset of the covariate cluster {great, fantastic, brilliant} at the node N11, the hierarchical arrangement unit 30 adds the covariate clusters {fantastic} and {brilliant} at the child positions of the node N11 to form the nodes N22 and N23 as shown in FIG. 6(A).

Next, it is assumed that the third rank clustering result includes the covariate cluster {fantastic, brilliant}. In this case, since the covariate cluster {fantastic, brilliant} is a subset of the covariate cluster {great, fantastic, brilliant} at the node N11, the node N11 is the parent node of the covariate cluster {fantastic, brilliant}. Therefore, the hierarchical arrangement unit 30 add the covariate cluster {fantastic, brilliant} at the child position of the node N11, which is also the parent position of the nodes N22 and N23, to form the node N3.

On the other hand, if the second and lower rank clustering results include the covariate cluster which does not have the parent node, the covariate cluster is not added to the hierarchical structure. For example, if the second or lower rank clustering result includes the covariate clusters {terrific} and {great, actor}, they are not added to the hierarchical structure. Namely, the covariate cluster in the second and lower rank clustering results is added to the hierarchical structure only when it has the parent node.

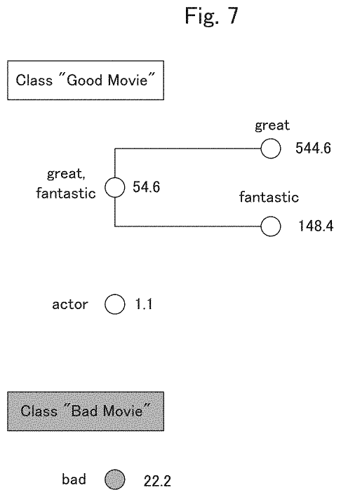

Next, examples of the hierarchical visualization will be described. FIG. 7 illustrates a first example of the hierarchical visualization of the clustering results. In FIG. 7, the hierarchical structure is drawn in the horizontal direction. FIG. 7 illustrates the example of visualizing the clustering results H₁ to H₃ shown in FIG. 4. For the clustering result H₁, the covariate clusters {great, fantastic} and {actor} are shown in association with the class “Good Movie”, and the covariate cluster {bad} is shown in association with the class “Bad Movie”. For the clustering result H₂, the covariate clusters {fantastic} and {great} are added to the child position of the node of the covariate cluster {great, fantastic}. While the clustering result H₂ includes the covariate clusters {bad} and {actor}, they are not added to the hierarchical structure because they have already been shown as the covariate clusters of the clustering result H₁. Also, while the clustering result H₃ includes the covariate cluster {fantastic, actor} as shown in FIG. 4, it is not added to the hierarchical structure because it does not have a parent node in the hierarchical structure.

In the example of FIG. 7, not only the hierarchical structure, but the score of each cluster is indicated at the position of the node. For example, the score of the covariate cluster {great, fantastic} is “54.6”. These scores are calculated by the score calculation unit 20 in step S20. It is preferable that the covariate clusters are aligned and arranged in the order of the score. In FIG. 7, the covariate cluster {great, fantastic} having the higher score than the covariate cluster {actor} is positioned on the upper side of the covariate cluster {actor}. Also, it is preferable to change the color of the nodes according to the class. In FIG. 7, the nodes associated with the class “Good Movie” and “Bad Movie” are shown by different colors.

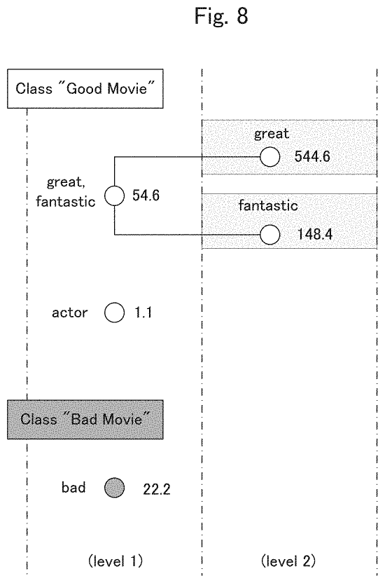

FIG. 8 illustrates a second example of the hierarchical visualization of the clustering results. In addition to the first example shown in FIG. 7, the second example divides the areas of the each clustering results. Specifically, the covariate clusters of the clustering result H₁ are shown in the “level 1” area, and the covariate clusters of the clustering result H₂ are shown in the “level 2” area. Also, the areas of the child nodes corresponding to the covariate clusters {great} and {fantastic} are colored.

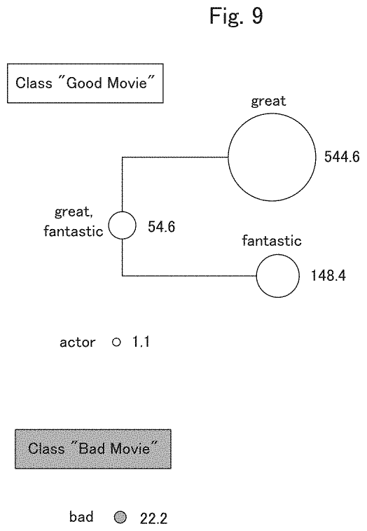

FIG. 9 illustrates a third example of the hierarchical visualization of the clustering results. The third example is different from the first example shown in FIG. 7 in that the size (area) of the node corresponds to the score of the covariate clusters. Typically, the size of the node may be proportional to the score of the covariate cluster.

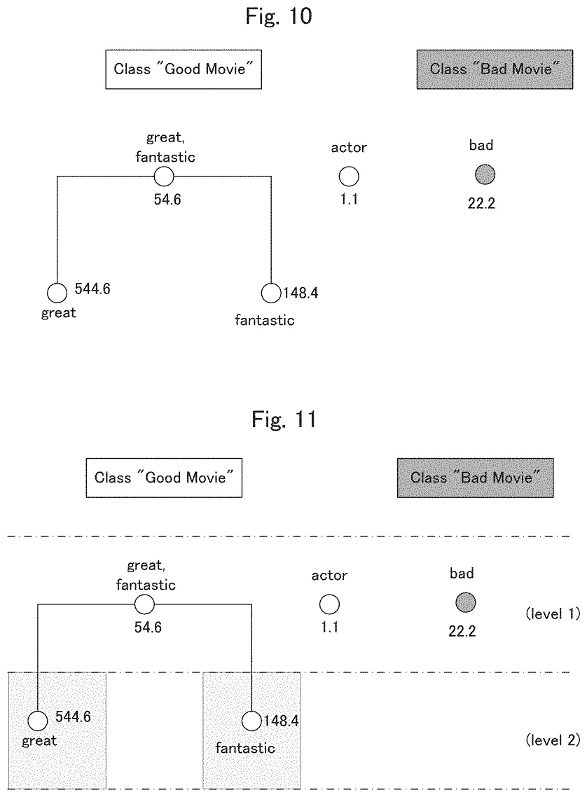

FIG. 10 illustrates a fourth example of the hierarchical visualization of the clustering results. The fourth example shows the same information as the first example shown in FIG. 7, but the hierarchical structure is drawn in the vertical direction. FIG. 11 illustrates a fifth example of the hierarchical visualization of the clustering results. The fifth example shows the same information as the second example shown in FIG. 8, but the hierarchical structure is drawn in the vertical direction.

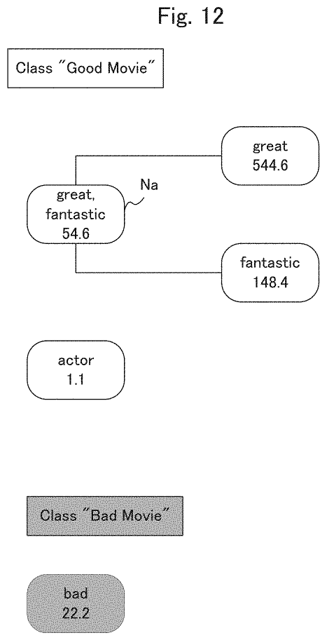

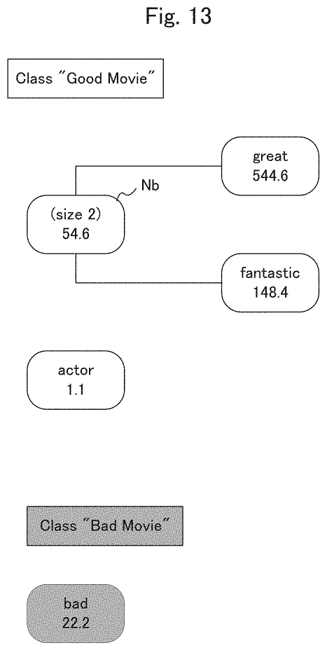

FIG. 12 illustrates a sixth example of the hierarchical visualization of the clustering results. The sixth example shows basically the same information as the first example of FIG. 7, but each node is shown as a box in which the name and the score of the covariate cluster are described. For example, the name of the covariate cluster {great, fantastic} and its score “54.6” are described in the box of the node Na. FIG. 13 illustrates a seventh example of the hierarchical visualization of the clustering results. The seventh example is different from the sixth example of FIG. 12 in that the node serving as a parent node indicates the number of the child nodes. For example, since the node Nb has two child nodes of the covariate clusters {great} and {fantastic}, the box of the node Nb describes “size (2)”, instead of the name of the covariate cluster {great, fantastic} like the sixth example. If the parent node has “n” child nodes, the box of the node describes “size (n)”. This enables simple display of the parent node having many child nodes.

### Second Embodiment

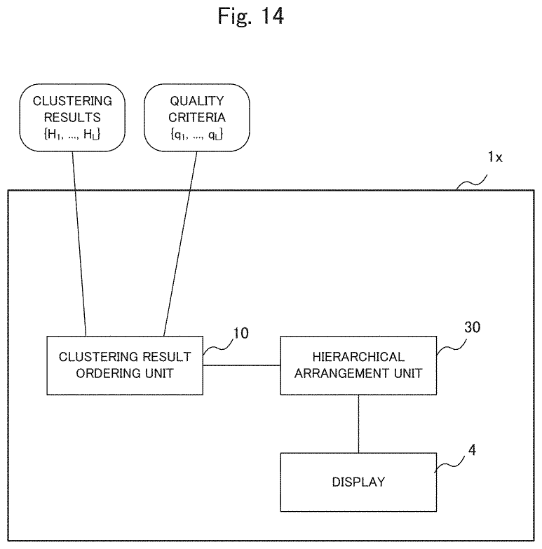

In the first example embodiment, the score calculation unit 20 calculates the score of the covariate clusters, and the hierarchical arrangement unit 30 aligns the nodes in the order of the scores and shows the score near the node. However, in the second example embodiment, the calculation of the score is omitted. FIG. 14 illustrates a functional configuration of the visualization device 1x according to the second example embodiment. As understood by the comparison with FIG. 2, the score calculation unit 20 in the first example embodiment is omitted. Instead of aligning the nodes in the order of the scores, the hierarchical arrangement unit 30 may align the nodes in an arbitrary order, e.g., in an alphabetical order, and does not show the scores near the nodes. Even by the second example embodiment, the hierarchical structure of the covariate clusters may be appropriately visualized.

While the invention has been particularly shown and described with reference to example embodiments thereof, the invention is not limited to these embodiments. It will be understood by those of ordinary skilled in the art that various changes in form and details may be made therein without departing from the spirit and scope of the present invention as defined by the claims.

The above-described example embodiments can be partially or entirely expressed by, but is not limited to, the following Supplementary Notes 1 to 14.

(Supplementary Note 1)
A visualization method of clustering results, comprising:
ordering plural clustering results based on quality criteria, each of the clustering results including covariate clusters;
creating a hierarchical structure including the covariate clusters as nodes; and
displaying the hierarchical structure.

(Supplementary Note 2)
The visualization method according to Supplementary Note 1, wherein the hierarchical structure includes the covariate clusters of the clustering result having a highest quality as root nodes.

(Supplementary Note 3)
The visualization method according to Supplementary Note 1, wherein the creating of the hierarchical structure adds the covariate clusters to the hierarchical structure in an order from the clustering result having a higher quality to the clustering result having a lower quality.

(Supplementary Note 4)
The visualization method according to Supplementary Note 1, wherein the creating of the hierarchical tree structure comprising:
detecting a parent node of the covariate cluster; and
adding the detected covariate cluster to a child position of the parent node.

(Supplementary Note 5)
The visualization method according to Supplementary Note 1, further comprising determining classes of the covariate clusters,
wherein the covariate clusters are associated with the classes in the hierarchical tree structure.

(Supplementary Note 6)
The visualization method according to Supplementary Note 5, wherein the nodes in the hierarchical structure are colored in accordance with the classes of the covariate clusters.

(Supplementary Note 7)
The visualization method according to Supplementary Note 1, further comprising calculating a score of each of the covariate cluster,
wherein the covariate clusters are aligned in an order of the scores in the hierarchical structure.

(Supplementary Note 8)
The visualization method according to Supplementary Note 1, further comprising calculating a score of each of the covariate cluster,
wherein the score of the covariate cluster is shown at a position of the node corresponding to the covariate cluster.

(Supplementary Note 9)
The visualization method according to Supplementary Note 1, wherein each node shows a name of the covariate cluster corresponding to the node.

(Supplementary Note 10)
The visualization method according to Supplementary Note 1, wherein each node shows a size of the covariate cluster corresponding to the node.

(Supplementary Note 11)
The visualization method according to Supplementary Note 10, further comprising calculating a score of each of the covariate cluster,
wherein each node shows the score of the covariate cluster corresponding to the node.

(Supplementary Note 12)
The visualization method according to Supplementary Note 1, further comprising calculating a score of each of the covariate cluster,
wherein a size of the node is proportional to the score of the covariate cluster corresponding to the node.

(Supplementary Note 13)
A visualization device of clustering results, comprising:
a memory storing instructions; and
a processor executing the instructions to:
order plural clustering results based on quality criteria, each of the clustering results including covariate clusters;
create a hierarchical structure including the covariate clusters as nodes; and
display the hierarchical structure.

(Supplementary Note 14)
A non-transitory computer-readable storage medium storing instructions that, when executed by a processor, cause the processor to:
order plural clustering results based on quality criteria, each of the clustering results including covariate clusters;
create a hierarchical structure including the covariate clusters as nodes; and
display the hierarchical structure.

### INDUSTRIAL APPLICABILITY

This invention can be used for evaluation of clustering results in a classification method.

### REFERENCE SIGN LIST

1 Visualization device

2 Processor

3 Memory

4 Display

5 Database

6 Storage medium

10 Clustering result ordering unit

20 Score calculation unit

30 Hierarchical arrangement unit

What is claimed is:

1. A visualization method of clustering results, comprising:
ordering plural clustering results based on quality criteria, each of the clustering results including covariate clusters;
creating a hierarchical structure including the covariate clusters as nodes; and
displaying the hierarchical structure.

2. The visualization method according to claim 1, wherein the hierarchical structure includes the covariate clusters of the clustering result having a highest quality as root nodes.

3. The visualization method according to claim 1, wherein the creating of the hierarchical structure adds the covariate clusters to the hierarchical structure in an order from the clustering result having a higher quality to the clustering result having a lower quality.

4. The visualization method according to claim 1, wherein the creating of the hierarchical structure comprising:
detecting a parent node of the covariate cluster; and
adding the detected covariate cluster to a child position of the parent node.

5. The visualization method according to claim 1, further comprising determining classes of the covariate clusters,
wherein the covariate clusters are associated with the classes in the hierarchical structure.

6. The visualization method according to claim 5, wherein the nodes in the hierarchical structure are colored in accordance with the classes of the covariate clusters.

7. The visualization method according to claim 1, further comprising calculating a score of each of the covariate cluster,
wherein the covariate clusters are aligned in an order of the scores in the hierarchical structure.

8. The visualization method according to claim 1, further comprising calculating a score of each of the covariate cluster,
wherein the score of the covariate cluster is shown at a position of the node corresponding to the covariate cluster.

9. The visualization method according to claim 1, wherein each node shows a name of the covariate cluster corresponding to the node.

10. The visualization method according to claim 1, wherein each node shows a size of the covariate cluster corresponding to the node.

11. The visualization method according to claim 9, further comprising calculating a score of each of the covariate cluster,
wherein each node shows the score of the covariate cluster corresponding to the node.

12. The visualization method according to claim 1, further comprising calculating a score of each of the covariate cluster,
wherein a size of the node is proportional to the score of the covariate cluster corresponding to the node.

13. A visualization device of clustering results, comprising:
a memory storing instructions; and
a processor executing the instructions to:
order plural clustering results based on quality criteria, each of the clustering results including covariate clusters;
create a hierarchical structure including the covariate clusters as nodes; and
display the hierarchical structure.

14. A non-transitory computer-readable storage medium storing instructions that, when executed by a processor, cause the processor to:
order plural clustering results based on quality criteria, each of the clustering results including covariate clusters;
create a hierarchical structure including the covariate clusters as nodes; and
display the hierarchical structure.
